(19) United States
(12) Patent Application Publication
(10) Pub. No.: US 2012/0205980 A1
(43) Pub. Date: Aug. 16, 2012

(54) STAND-ALONE ELECTRIC POWER GENERATION UNIT

(76) Inventor: Robert Ray Holcomb, Nokomis, FL (US)

(21) Appl. No.: 13/503,552

(22) PCT Filed: Oct. 19, 2010
(86) PCT No.: PCT/IB10/02656

§ 371 Date: Apr. 23, 2012

Related U.S. Application Data
(60) Provisional application No. 61/279,525, filed on Oct. 22, 2009.

(51) Int. Cl. H02J 3/38

(52) U.S. Cl. 307/51

(57) ABSTRACT

A method and apparatus for sustained power self-generation using a reduced drag high efficiency (HE) electric machine are disclosed. Electric power supply having a power level is produced from an electrical generation unit including an HE electric machine and a non-fossil fuel unit such as a hydrogen unit, a hydro unit, a battery, a power grid and so on. Portions of the electric power supply are diverted to the electrical generation unit, another electrical generation unit including an HE electric machine and a non-fossil fuel unit, and a power distribution grid. The HE machines includes a conversion efficiency factor rating of greater than 1 hp of input power to 746 watts of output power.

### FIELD

The present invention relates generally to a decreased drag electric power generating machine, and more particularly to diverting generator power to operate a drive system.

### BACKGROUND

Rapid consumption of exhaustible energy from the earth, largely in the form of fossil fuels and rapid depletion of associated energy resources and accompanying environmental pollution and climate change drives the clear need for alternative energy supplies. Existing energy supplies must be used more efficiently.

In view of these and other issues, the need for sustainable power generation units is obvious. Renewable energy sources such as solar, wind, hydroelectric, electrostatic, temperature differential and geothermal energy have significant problems of availability, reliability and expense. Even gravity, if it could be efficiently harnessed, could provide a most attractive alternative.

One contribution to increasing consumption efficiency and sustainability is to increase the efficiency of electrical power generation. Increasing the conversion efficiency associated with converting mechanical energy to electrical power can provide potentially large gains. An ordinary electric generator typically converts close to 99% of supplied mechanical power into electric power based on a conventional 100% conversion efficiency comparison factor of one horsepower per 746 watts generated, however such a factor is somewhat misleading as true efficiency that takes into account friction losses and the like, may be significantly less. Still further gains can be achieved using superconducting technology. For example, a superconducting generator can be around 10-times smaller than a conventional generator for the same output.

While such gains are attractive, the expenses and challenges of implementing superconducting solutions are well known. It is therefore also desirable to achieve efficiency gains that are centered around more conventional structures. For example, if the reaction force or magnetic drag can be reduced or eliminated from the armature of an alternating current (AC) or direct current (DC) generator, the efficiency could be theoretically increased by 400-500%. Under such an increase in efficiency, one horsepower could generate up to 3,730 watts. Still further, by combining superconductivity with reduced magnetic drag, a greater than 10-fold increase in efficiency may be possible.

To better understand the rudiments of power generation, it is commonly known that every atom has a nucleus composed of positively charged protons and uncharged neutrons. Negatively charged electrons orbit the nucleus. In most atoms, the number of electrons is equal to the number of protons in the nucleus, so that there is no net charge. If the number of electrons is less than the number of protons, then the atom has a net positive charge. If the number of electrons is greater than the number of protons, then the atom has a net negative charge.

While on an aggregate scale, the universe is electrically neutral, local concentrations of charge throughout biological and physical systems are responsible for all electrical activity. Further, not all electrons are involved in the structure of material. Vast numbers of electrons which are loosely bound “electrons at large” are in equilibrium with outer shell electrons of atoms in the environment. It is from this pool of electrons in the atmosphere and in the ground, when set into combined motion along a path, that an electric current is generated. Thus, if electrical pressure from a generator is applied to an electrical conductor, such as copper wire, and the circuit closed, electrons will flow along the wire from negative to positive, from atom to atom forming an electric current.

The movement of energy associated with electrical current flow occurs at the speed of light, or approximately 186,000 miles per second.

For conceptual purposes, a wire connected to a DC power source will cause electrons to flow through the wire in a manner approximating water flowing through a pipe. The path of any one electron can be anywhere within the volume of the wire or even at the surface. When an AC voltage is applied across a wire it will cause electrons to vibrate back and forth in such a manner as to generate magnetic fields that push electrons toward the surface of the wire. As the frequency of the applied AC signal increases, the electrons are pushed farther away from the center and toward the surface.

A conventional electric power generator contains two main parts: a stator and a rotor. The stator is generally made of iron or other ferro-magnetic material and contains long slots having a certain depth and in which wire coils are wound in such a fashion to allow electric power to be generated when magnetic fields emanating from the rotor move past the coils. The rotor contains a specific arrangement of magnets, which are generally wound armature electro-magnets whose strength is governed by the amount of current flowing in the armature windings. It should be noted that, while permanent magnets have attractive properties, the use of permanent magnets, particularly in large scale applications, have traditionally been avoided due to the relatively high cost of magnetic material. When the rotor spins inside the stator, the magnetic fields from the rotor induce a current in the stator windings thus generating what is referred to as electrical power.

The energy required to spin the rotor is typically supplied by a drive unit of some kind, such as an electrical drive motor, diesel or other fossil fuel motor, steam turbine or the like. At typical efficiencies, only 20% of the energy input by the driver motor is devoted to creating electric power. The remaining 80% is dissipated by magnetic drag, or braking forces, that develop between the rotor and the stator.

When current is supplied to a load from a conventional generator, a magnetic force or reaction force is created by the flow of the load current in the generator conductors that opposes the rotation of the generator armature. If the load current in the generator conductors increases, the drag associated with the reaction force increases. More force must be applied to the armature as the load increases to keep the armature from slowing. Increasing drag and increasing load current leads to decreasing conversion efficiency and can eventually lead to destructive consequences for generator equipment.

The well known laws of thermodynamics have been applied in historical and current designs of electric power generators and electric motors. The laws of thermodynamics are described below.

1. First Law of Thermodynamics (“First Law”)—The First Law is often called the Law of Conservation of Enemy. According to the First law, the total amount of energy in the universe is constant but is not evenly distributed. The First Law suggests that energy can be transferred from one system to another system, but the energy cannot be created nor destroyed. Energy is however interchangeable with matter and that relationship was E=MC². In this equation, energy (E) is equal to matter (M) times the square of a constant (C)

2. Second Law of Thermodynamics (“Second Law”)—According to the

Second Law, heat cannot be transferred from a colder to a hotter body. Energy transfer must be in one direction and the process is irreversible. The Second Law predicts that entropy (measure of the disorder or randomness of energy and matter in a system) of an isolated system always increases with time. A=πr²

3. Third Law of Thermodynamics (“Third Law”)—According to the Third Law, if all thermal motion of molecules (kinetic energy) could be removed, a state of absolute zero would occur. This temperature is believed to be minus 273.15 degrees Celsius or “0” Kelvin. The universe theoretically should reach absolute zero when all energy and matter is randomly distributed across the universe.

Known equipment and known motive machines have operated and continue to operate in a paradigm of scientific understanding based on the above laws. For example, in a known electric power generator, 1 horsepower of kinetic energy delivered to the shaft of an electric power generator can generate 746 watts of electric energy i.e. 1 hp=746 watts.

It would be desirable therefore to increase generator efficiency by reducing the motor reaction effect and the corresponding negative consequences and by using efficiency gains to power a generator drive system.

### SUMMARY

While it may appear that using such efficiency gains to power the generator from which the efficiency gains were obtained, would violate the laws of thermodynamics, advantages provided in accordance with embodiments are set forth herein below.

Various exemplary embodiments are discussed and described herein involving aspects of an electric machine that can provide sustained power self-generation using a reduced drag high efficiency (HE) electric machine. A first electric power supply having a first level of power can be produced from a first electrical generation unit including a first HE electric machine and a first non-fossil fuel unit. Respective portions of the first electric power supply having a second level of power can be diverted to at least two of: the first electrical generation unit; a second electrical generation unit including a second HE electric machine and a second non-fossil fuel unit; and a power distribution grid. The first and the second HE machines includes a conversion efficiency factor rating of greater than 1 hp of input power to 746 watts of output power. At least a portion of the first electric power supply can be stored in a power storage device, recovered and returned as needed. In accordance with various embodiments, at least one of the first and second non-fossil fuel units includes a hydrogen drive system, a hydro drive system, a hydraulic drive system, an electric power grid, a power storage device such as, for example, a battery or a capacitor, a standard efficiency generator, or a standard efficiency motor. At least one of the first and the second HE electric machine includes a HE generator, an HE motor, or an HE motor co-generation unit. At least one of the first and second non-fossil fuel units includes a standard efficiency generator. In accordance with an embodiment, a connection between the first HE electrical generation unit and the second HE generation unit includes a first efficiency multiplier and a connection between the second HE generation unit and a third HE generation unit includes a second efficiency multiplier such that the gains in efficiency can result in a multiplier effect.

In an embodiment, an assembly for providing self-sustaining generation can include a first reduced drag high efficiency (HE) electric machine, a first non-fossil fuel unit coupled to the first HE electric machine to form an first HE generation unit, an electrical output connection between the first HE generation unit and an electrical load, and an electrical feedback connection coupled between the electrical output connection of the first HE generation unit and an electrical input of the first HE generation unit, The electrical output connection outputs a first level of power to the electrical load and outputs a second level of power to the first HE generation unit. The electrical load includes at least one of: a second HE, generation unit including a second HE electric machine and a second non-fossil fuel unit; and a power distribution grid. The first and the second HE generation units operate at an efficiency greater than ‘hp of input power to 746 watts of output power. The assembly can further include a power storage device coupled to the electrical output connection, the power storage device capable of having at least a portion of the first electric power supply stored therein and, for example, a variable frequency drive coupled to the power storage device and the first HE generation unit, the variable frequency drive recovering and returning the stored at least a portion of the first electric power supply as needed. A power storage device capable of having at least a portion of the first electric power supply stored therein can be coupled to the electrical output connection. A variable frequency drive can be coupled to the power storage device and the first HE generation unit and can recover and return the stored at least a portion of the first electric power supply as needed. In accordance with various embodiments, at least one of the first and second non-fossil fuel units includes a hydrogen drive system, a hydro drive system, a hydraulic drive system, an electric power grid, a power storage device such as, for example, a battery and a capacitor, a standard efficiency generator, a standard efficiency motor, and the like. At least one of the first and the second HE electric machine includes an HE generator, an HE motor, or an HE motor co-generation unit. A connection between the first HE electrical generation unit and the second HE generation unit is constituted according to a first efficiency multiplier and a connection between the second HE generation unit and a third HE generation unit is constituted according to a second efficiency multiplier. When the storage device includes at least one of a battery and a capacitor a rectifier coupled between the electrical feedback connection and the storage device can be included.

It is an object therefore to magnify electric power during generation by using a standard electric motor to drive a generator having an efficiency higher than that of the electric motor drive thereby producing surplus usable energy.

It is an object to use a high efficiency generator with a hydrogen driven engine to provide a self-sustaining electric power.

It is an object to use a high efficiency generator and a standard efficiency electric driving motor to produce residual power to operate the driving motor and additional usable power.

It is an object to use a high efficiency electric generator and a standard efficiency electric driving motor to produce residual power to operate the driving motor through storage batteries and capacitors.

It is an object to use a high efficiency electric generator with a standard efficiency electric driving motor to produce residual power to operate the driving motor through a hydraulic system with a nitrogen accumulator as a short-term stored energy supply.

It is an object to use a high efficiency electric generator with a standard efficiency electric driving motor to produce residual power to operate the driving motor through a hydro storage system utilizing a water pump, a water storage reservoir and gravity flow through a generator turbine system.

It is a further object of the present invention to use a high efficiency electric generator with a standard efficiency electric driving motor to produce residual power to operate the driving motor through a net metering hookup with an existing power grid.

### BRIEF DESCRIPTION OF THE DRAWINGS

In order that embodiments may be fully and more clearly understood by way of non-limitative examples, the following description is taken in conjunction with the accompanying drawings in which like reference numerals designate similar or corresponding elements, regions and portions, and in which:

FIG. 1 is a diagram illustrating an exemplary configuration for the magnification of electric power through a standard electric motor driving an electric generator of a higher efficiency than the electric drive motor;

FIG. 2 is a diagram illustrating a high efficiency electric generator, a hydrogen generator, and a hydrogen-driven standard drive engine;

FIG. 3 is a diagram illustrating a high efficiency electric generator, a standard efficiency electric driving motor and a bank of energy storage devices;

FIG. 4 is a diagram illustrating a high efficiency electric generator, a standard efficiency electric driving motor, and a hydraulic system with a nitrogen accumulator as a short term stored energy supply; and

FIG. 5 is a diagram illustrating a high efficiency electric generator, a standard efficiency electric driving motor, and a hydro storage system utilizing a water pump, a water storage reservoir and gravity flow through a generator turbine system.

### DETAILED DESCRIPTION

In accordance with various exemplary embodiments discussed and described herein, and by way of brief summary, an exemplary electric power generation process is disclosed whereby a high efficiency generator in which one horsepower of mechanical energy can be used to generate greater than the conventional limit of 746 watts.

Exemplary embodiments make use of a new paradigm of efficiency in which 1 hp of kinetic energy input onto the shaft of an electric power generator in accordance with exemplary embodiments yields approximately 3,000 watts of electric energy output from the generator leading to a generation factor whereby 1 hp=3,000 watts. If the kinetic energy delivered onto the shaft of the generator is driven by a 1 hp motor which consumes 746 watts and 746 watts from the output of the of the generator is fed back to the driver motor through an interface such as a battery pack and proper conversion device, a net of 2,254 watts of usable power is generated.

Paradigm shift is a term first coined by Thomas Kuhn in his book “The Structure of Scientific Revolutions,” published 1962. The term is used to reference a change in basic assumptions within the ruling theory of science. The current assumptions concerning electric energy generation by rotating machinery based electric power generators are based upon historical observations from electromotive machines. The classic observations are based on a particular design of the generator and result in design paradigms in which only 20 percent of the kinetic energy input onto the shaft of the generator is used to generate electric power, when operating at full load. The remaining 80 percent is dissipated by competing destructive magnetic forces within the generator resulting from sub-optimum generator design. The High Efficiency Generator described in accordance with embodiments in the present and related patent applications has been redesigned to reduce the 80 percent kinetic energy loss from the destructive magnetic forces by greater than 90 percent. Therefore at full load, a High Efficiency Generator, for example as described herein, requires approximately 24 percent of the energy required to drive a classic generator at full load. Accordingly, it is possible to generate the same amount of energy in accordance with a higher efficiency paradigm using approximately one-fourth the kinetic energy input that would be required with conventional paradigms as illustrated by Equation 1:

$$\begin{matrix}EI = \frac{HE}{LE} \\ = \frac{3000 Watts / hp}{746 Watts / hp} \\ = \frac{4}{1} or 400 \% increased efficiency\end{matrix} \qquad EQ ( 1 )$$

where, EI=Efficiency Increase, HE=High Efficiency Paradigm Output in watts per horsepower of kinetic energy input, LE=Low Efficiency Paradigm output in watts per horsepower of kinetic energy input,

The gains provided by the high efficiency paradigm are confirmed by the data presented below which was obtained from computer modeling and experimental data obtained from devices as set forth, for example, in International Applications PCT PCT/IB2010/000043 entitled “Decreased Drag High Efficiency Electric Generator,” filed Jan. 12, 2009 and PCT/IB2010/001693 entitled “Decreased Drag Electric Machine with Dual Stator and Distributed High Flux Density Slot Rotor Pairs,” filed Feb. 2, 2010.

Data was first taken from a 1800 watt single-phase generator operating in accordance with a generator low efficiency paradigm where 1 horsepower will produce 746 watts, by connecting the output leads to a single-phase resistive load bank and the generator being driven by a three-phase electric motor operating in accordance with a motor corollary of the low efficiency paradigm where 746 watts is required to put out 1 hp onto the shaft of the generator. In a test case, a total load of 1,146.6 watts was placed on the load bank coupled to the generator requiring 1300 watts to service. For each 1000 watts of power in the form of kinetic energy from the driver motor to the generator, 882 watts of electric power were generated. Therefore the input to output ratio was experimentally determined to be 0.882:1.

An example of a high efficiency generator can be found in International Applications PCT PCT/IB2010/000043 entitled “Decreased Drag High Efficiency Electric Generator,” filed Jan. 12, 2009 and PCT/IB2010/001693 entitled “Decreased Drag Electric Machine with Dual Stator and Distributed High Flux Density Slot Rotor Pairs,” filed Feb. 2, 2010 the contents of both of which are incorporated herein by reference. Reference herein to “high efficiency generator” can include generators of the kind disclosed and described in the above applications, or other high efficiency generators such as a combination motor/generator or co-generator such as that described in International Application PCT/IB20______, entitled “High Efficiency Electric Motor/Power Cogeneration Unit,” filed ______, the contents of which are incorporated herein by reference.

Data was next taken from one of the embodiments of PCT/IB2010/000043 in which the generator operates in accordance with a different paradigm such that 1 hp of kinetic energy on the shaft of the generator can yield 2,984 watts or a ratio of 4:1 over the conventional paradigm.

One of the embodiments from application number PCT/IB2010/001693 —“Decreased Drag Electric Machine with Dual Stator and Distributed High Flux Density Slot Rotor Pairs” was modeled using Maxwell 2-D computer software to determine the efficiency based on analysis of kinetic energy input onto the shaft of the generator and energy output by the generator. The power output to power consumption ratio is 6.8:1. The data is presented below in Table 1.

TABLE 1
Net Output Capacity

| | | |
|---|---|---|
| Power generated | kVA | 139.1 |
| Excitation power | kW | 1.8 |
| Drive power | kW | 13.7 |
| System losses | kW | 0.8 |
| Assumed power factor | | 0.90 |
| Total generator Output | kVA | 123.0 |
| | kWe | 110.7 |

In accordance with table one, the ratio of power generated to power consumed is 8.6:1, while the ratio of power output to power consumed is 6.8:1. The data in Table 1 therefore show that, for a driver motor operating in accordance with one energy paradigm and a generator to which the driver motor is coupled, operating according to another, higher efficiency paradigm, that energy is not created in violation of laws of physics. Rather, the gains are associated with the fact that power generated by operating a driver motor which in accordance with a lower efficiency paradigm transmits kinetic energy through a physical driver shaft into a generator which operates in accordance with a higher efficiency paradigm, thereby expanding the amount of usable energy.

While, as noted, the above gains do not violate the laws of thermodynamics, the phenomenon suggests a need for supplementary laws. For example, it might be stated that when a generator driver motor operating in accordance with a lower energy efficiency paradigm is used to drive an electric power generator through a physical and/or mechanical connection operating in accordance with a higher efficiency paradigm, or vice versa, whereby the driver motor operates in accordance with a higher efficiency paradigm than the generator, the result is an expansion in the amount of available usable energy generated by the system, due to a multiplier effect associated with the differences in efficiency between the driver and the generator. Based on the gains, the driver motor may be powered by a portion of the generated excess power through a suitable interface and the remaining output may be used for other desired purposes. The above described phenomenon requires a disparity between the efficiency of the generator and the driver motor resulting from, for example, 1) a normal efficiency drive motor and a high efficiency generator or 2) a high efficiency drive motor and a normal efficiency generator.

Still further, in an example, a classic electric motor consuming 746 watts of electric energy drives a high efficiency generator outputting 3,000 watts. The net power from the generator is 2,254 watts, significantly more than the energy required to operate the drive motor. An energy-storing interface placed between the generator and the driving motor can supply the energy for the drive motor. Suitable systems for energy storage can include batteries, capacitors, and suitable non-ferrous systems can include hydraulic systems with a gas accumulator, a hydro storage/pump/turbine system, a hydrogen generator with hydrogen powered turbine or internal combustion engine and the like. While not specifically illustrated, renewable energy sources such as solar, wind, wave energy sources and the like can be used as non-ferrous sources. Interaction with an existing electric power grid can also be used.

The above overview is exemplary in nature to provide a brief overview of the invention. A better understanding is provided herein below in the description that accompanies the figures. The structure and mechanism of exemplary embodiments allows the use of a high efficiency electric power generator along with a standard efficiency electric drive motor through an exemplary interface in accordance with embodiments to provide magnified electric power in a stand-alone power station. The embodiments described herein make use of an electro-mechanical efficiency gain that is shifted from the output of a high efficiency electric generator to the electro-mechanical mechanisms of the driver motor as facilitated through an exemplary interface mechanism.

With reference to the figures, various exemplary processes are illustrated whereby electric power is effectively magnified, according to a multiplier effect Mₑ through the use of a standard electric motor, or other non-fossil driving source, driving an electric generator that performs at a higher efficiency than the electric drive motor, thereby producing an effective surplus of usable electric energy. In alternative embodiments, a standard generator can be driven by a high efficiency electric motor with a similar effect. Further, while the multiplier effect Mₑ is described herein as occurring between different stages, the exact point at which a multiplier effect can be seen depends, for example on the number of stages and the particular configuration. In general, a multiplier effect can be realized when the efficiency gain from use of an HE machine is fed back to operate the machine and also fed forward to drive additional HE generation stages.

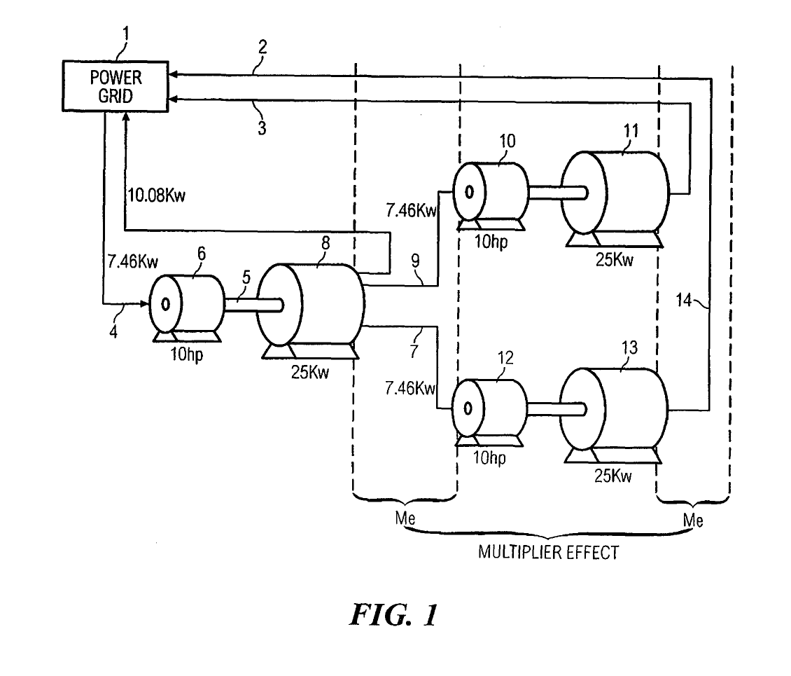

In an embodiment, as illustrated in FIG. 1, electric power is initially taken from power grid 1 in an illustrative amount of approximately 7.46 kw through electrical conduit 4, such as a wire conductor, bus bar or the like, to drive motor 6 having an illustrative rating of 10 hp. Motor 6 is configured to drive a high-efficiency generator, such as generator 8, through a shaft 5 to produce an illustrative 25 kw of electric power. In the example, approximately 10.08 kw of the output of generator 8 can be fed back to the power grid, while approximately 7.46 kw is fed to each of two 10 hp drive motors 10 and 12 respectively, through electrical conduit 9 and electrical conduit 7 from generator 8 constituting a net gain due to the multiplier effect Mₑ between the first high efficiency generation stage and the subsequent high efficiency generation stage. Electric motor 10, in turn, drives another HE generator 11 to generate 25 kw of energy to feed back to the power grid through electrical conduit 3. Electric motor 12 drives HE generator 13 to generate 25 kw of power to feed back to the power grid through electrical conduit 14 and electrical conduit 2. The operation of HE generators 11 and 13 constitute a second stage of gain due to the multiplier effect Mₑ.

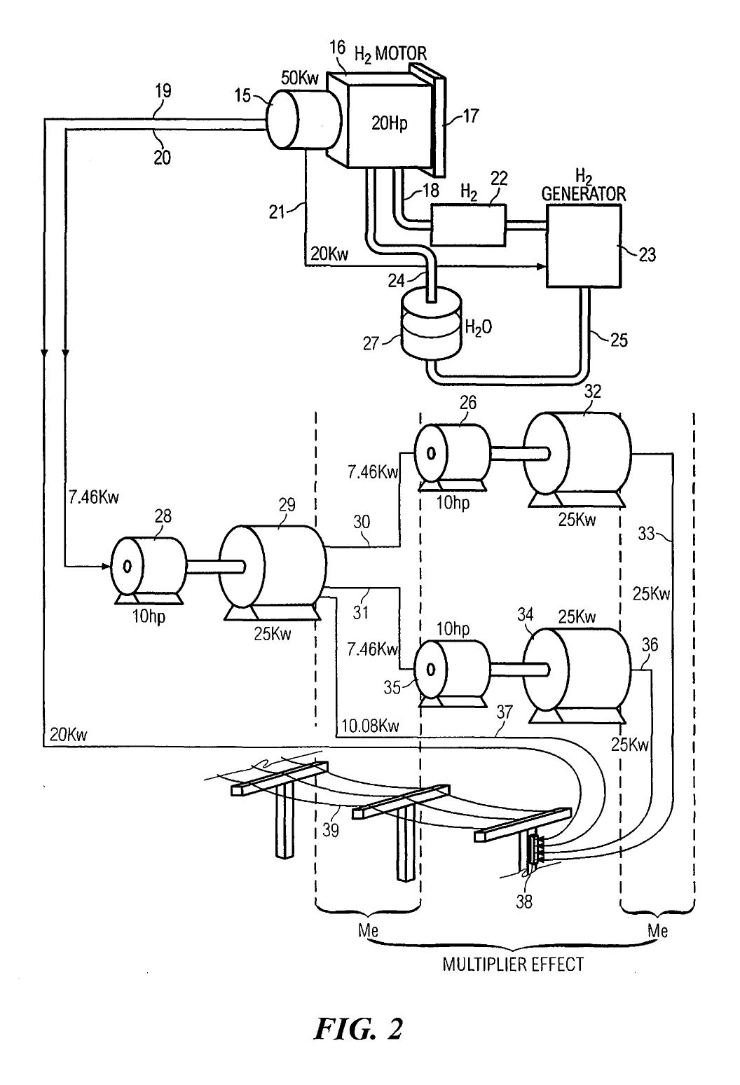

With reference to FIG. 2, an exemplary interaction between a high efficiency electric generator, such as HE generator 15, with a hydrogen generator 23 is illustrated. In the example, a 20 hp internal combustion engine 16 can be configured to drive HE electric generator 15, which, in turn, drives a hydrogen generator 23, to thereby provide self-sustaining electric power through the feedback utilization of the efficiency gains. The 20 hp hydrogen-fueled internal combustion engine 16 can be operated through control panel 17 and fueled by hydrogen generated by hydrogen generator 23 and contained in storage tank 22 through the hydrogen conduit line 18 into hydrogen-fueled internal combustion engine 16. The hydrogen-fueled internal combustion engine 16 drives 50 kw HE generator 15 that feeds approximately 20 kw of power through electrical conduit 21 to the hydrogen generator 23, which, in turn, supplies, for example, gaseous hydrogen, or the like, to the hydrogen storage tank 22 from which the hydrogen is supplied to the hydrogen fueled internal combustion motor 16.

HE generator 15 supplies an additional 20 kw of power via electrical conduit 19 to the power grid 39 via transformer 38. HE generator 15 supplies 7.46 kw of electric power via electrical conduit 20 to a 10 hp electric motor 28 that drives a 25 kw HE generator 29 for supplying approximately 10 kw of power to the electric power grid 39 via electrical conduit 37 and transformer 38. HE generator 29 further supplies approximately 7.46 kw to drive motors 26 and 35, respectively, through electrical conduits 30 and 31 constituting a net gain due to the multiplier effect Mₑ. The 10 horsepower drive motors 26 and 35 drive 25 kw generators 32 and 34, which, in turn, supply 25 kw of electric power via electrical conduit 33 to the electric power grid 39 via transformer 38 constituting an additional gain due to the multiplier effect Mₑ. HE generator 34 sends 25 kw of electric power via electrical conduit 36 to the electric power grid 39 via transformer 38.

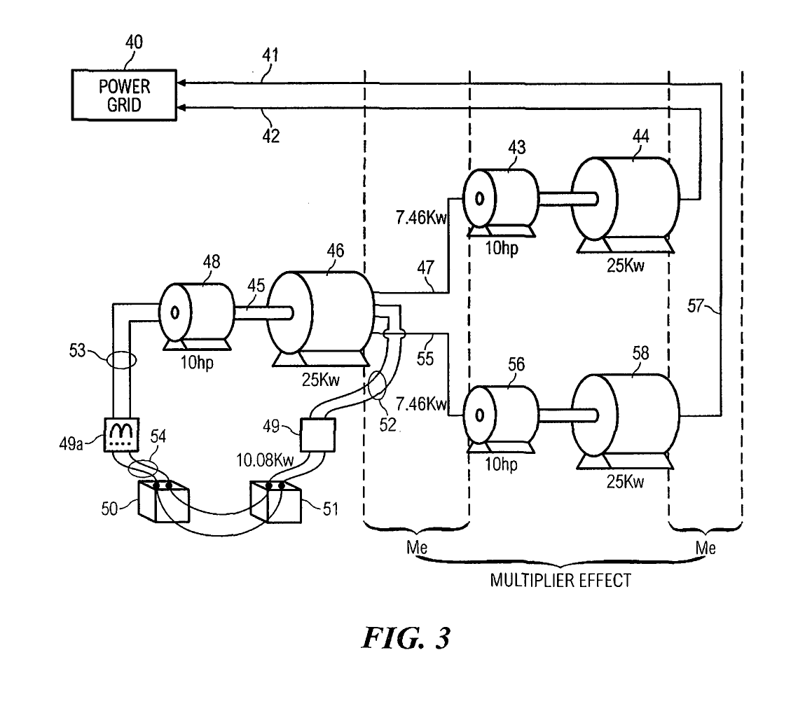

While the above described embodiments allow for the generation of additional power through diversion of a portion of the HE generator output, in alternative embodiments, storage devices can be used to store the surplus power generated as a result of gains in efficiency. FIG. 3 illustrates the exemplary interaction of a HE electric generator, such as HE generator 46, with a standard efficiency electric driving motor such as motor 48, through a bank of batteries, capacitors, electrical energy storage devices, or the like, such as storage devices 50 and 51. In the present example, electric motor 48 can be a 10 hp three-phase standard induction motor driving a 25 kw HE generator 46 through shaft 45. HE generator 46 supplies 10.08 kw through electrical conduit 52 to a full wave bridge rectifier 49. The direct current energy output from the full wave rectifier is then stored in storage devices 50 and 51, which output stored power, or a combination of stored power and converted power, depending on demand level, through electrical conduit 54 to a variable frequency drive 49a which can convert the stored DC power to AC power that drives a 10 hp motor 48 through electrical conduit 53. HE generator 46 outputs about 7.46 kw of power to 10 hp motors 43 and 56 through electrical conduit 47 and 55 respectively. Two 10 hp motors 43 and 56 drive HE generators 44 and 58 which each put out 25 kw through electrical conduit 42 and 57 respectively to the electric power grid or for use at the point of generation constituting a stage of gain due to the, multiplier effect Mₑ.

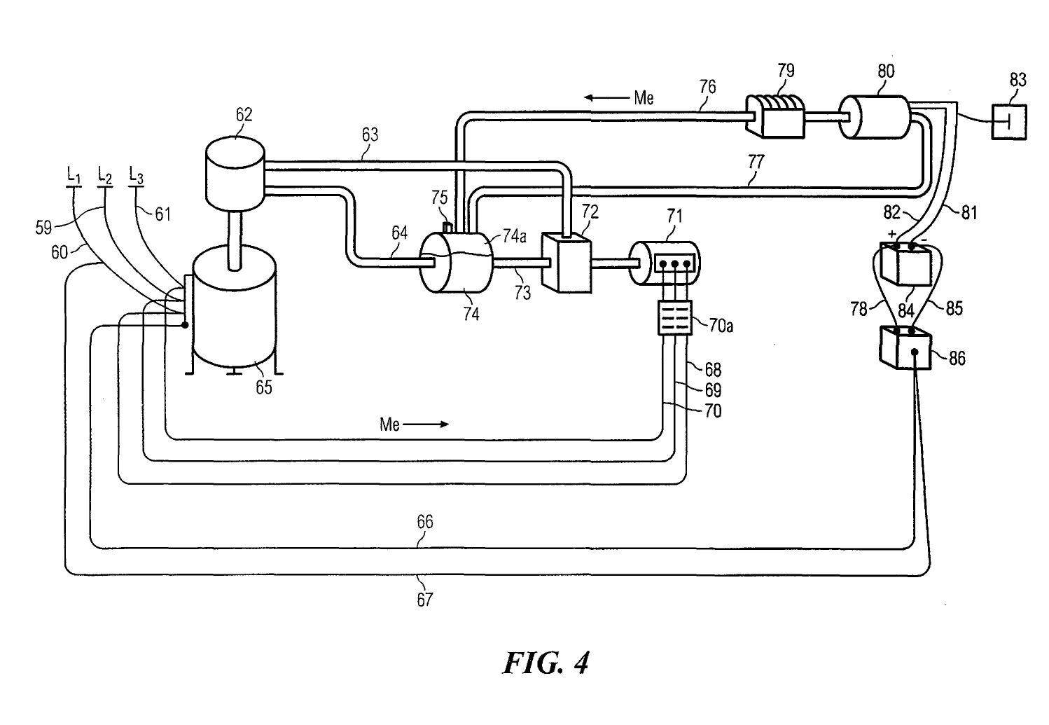

While in the above described embodiments, batteries, capacitors can be used as storage devices, other storage devices can be used. FIG. 4 illustrates an exemplary interface between a HE electric generator, such as HE generator 65, a standard efficiency electric drive motor, a hydraulic system and a nitrogen accumulator, which serves as a short term stored energy supply. HE generator 65, which is a three-phase 150 kw electric generator, can output 100 kw of power through phase legs 59, 60 and 61 to a load point or can be fed to the electric power grid. The remaining power can be fed back and used both in variable frequency drive 70a and rectifier 86 to facilitate generation as will be described in greater detail hereinafter constituting stages of gain due to the multiplier effect Mₑ.

It will be noted that generator 65 is driven by hydraulic motor 62 that receives hydraulic power, in the form of pressurized hydraulic fluid supplied through hydraulic conduit 64 from, for example, a hydraulic storage and pressure tank 74 which contains a nitrogen accumulator 74a. The nitrogen accumulator is pressured by pressure pump 79 which is driven by DC motor 80 to supply pressurized nitrogen gas to the pressure tank 74 through gas conduit 76. In response to sensed pressure levels in the nitrogen accumulator 74a, DC power lines 81 and 82 of a motor power supply circuit can be open and closed by nitrogen accumulator 74a pressure switch 75 through electrical conduit 77. DC motor 80 is powered from battery 84, for example, when the power lines 81 and 82 are switched on. Battery 84 can be charged via leads 78 and 85 from full wave bridge rectifier 86 which is powered from phase leg #L1 through electrical conduit 67 and neutral 66. Hydraulic pressure tank 74 can be charged by pressurized hydraulic fluid entering through the hydraulic conduit 73 and pressurized by mechanical pressure pump 72, which receives return hydraulic fluid from hydraulic motor 62 through hydraulic conduit 63. Mechanical pressure pump 72 can be driven by variable speed electric motor 71, which is powered through variable frequency drive 70a with 20 kw of three-phase power conducted from HE generator 65 through three phase electrical conduits 68, 69 and 70.

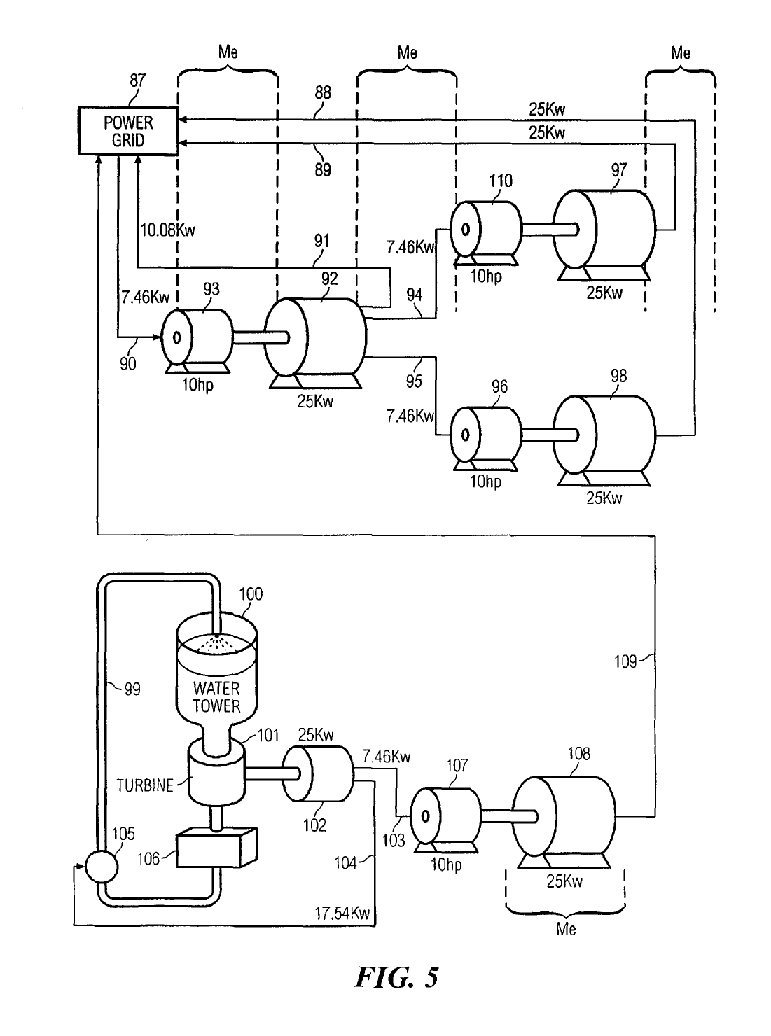

In an embodiment, a hydro-powered system can be used to drive a HE generator. FIG. 5 illustrates an interface of a HE generator with a standard efficiency electric driving motor powered through a hydro storage system including a water pump, a water storage reservoir, and gravity flow through a generator turbine system. Water tower storage tank 100 can provide water to turbine 101 that flows, for example, under gravitational pressure. Turbine 101 can drive a 25 kw HE generator 102 which feeds 17.54 kw of three-phase power back to water pump 105 for pumping wastewater that has passed through turbine 101, from receiving reservoir 106 back to the water tower reservoir 100 through water conduit 99. HE generator 102 can also send the remainder of its output power, or 7.46 kw of electric power to 10 hp motor 107 through electrical conduit 103. Electric motor 107 drives generator 108, which generates 25 kw of electric power to the power grid 87 through electrical conduit 109 constituting a stage of gain due to the multiplier effect Mₑ.

It will be appreciated that by supplying an illustrative 25 kw to the power grid 87, at a cost of a self sustaining 7.46 kw, the hydro power configuration can perpetuate additional self sustaining electric systems due to the combined multiplier effects Mₑ associated with various efficiency gain stages. For example, considering the 25 kw input to power grid 87 from HE generator 108, electric 10 hp motor 93 takes 7.46 kw of power from the power grid 87 through electrical conduit 90 to power a 25 kw HE generator 92 constituting a gain stage. A resulting output of 10.08 kw of power is supplied back to the power grid 87 through electrical conduit 91. HE generator 92 also supplies 7.46 kw of electric power to electric motor 96 and 7.46 kw of electric power to electric motor 110 respectively, through electrical conduits 94 and 95. Electric motors 96 and 110 are configured to drive 25 kw HE generator 97 and 25 kw HE generator 98 constituting additional gain stages. The power output of HE generators 97 and 98 is transmitted to the power grid 87 through electrical conduits 88 and 89.

While embodiments have been described and illustrated, it will be understood by those skilled in the technology concerned that many variations or modifications in details of design or construction may be made without departing from the present invention. For example, while standard motors are described herein as powering HE generators, in an alternative embodiment, a standard efficiency electric generator can be driven with a HE electric motor and thereby produce a net increased in electric power output due to the efficiency gains of the HE configuration as described, for example, in International Applications PCT PCT/IB2010/000043, PCT/IB2010/001693 and PCT/IB20______ noted above, without departure from the inventive gist. Further, while several non-fossil fuel drive systems are described, such as motor drive systems, hydrogen drive systems, hydro powered systems, hydraulic/electric systems, or the like, other non-fossil fuel systems are possible such as, renewable sources such as but not limited to solar systems, wind driven systems, wave driven systems or the like as will be appreciated by one of skill in the art.

1. A method for sustained power self-generation using a reduced drag high efficiency (HE) electric machine comprising:
producing a first electric power supply having a first level of power from a first electrical generation unit including a first HE electric machine and a first non-fossil fuel unit; and
diverting respective portions of the first electric power supply having a second level of power to at least two of:
the first electrical generation unit;
a second electrical generation unit including a second HE electric machine and a second non-fossil fuel unit; and
a power distribution grid,
wherein the first and the second HE machines includes a conversion efficiency factor rating of greater than 1 hp of input power to 746 watts of output power.

2. The method of claim 1, further comprising:
storing at least a portion of the first electric power supply to a power storage device; and
recovering and returning the stored at least a portion of the first electric power supply as needed.

3. The method of claim 1 and claim 2, wherein, wherein at least one of the first and second non-fossil fuel units includes a hydrogen drive system.

4. The method of claim 1 and claim 2, wherein at least one of the first and second non-fossil fuel units includes a hydro drive system.

5. The method of claim 1 and claim 2, wherein at least one of the first and second non-fossil fuel units includes a hydraulic drive system.

6. The method of claim 1 and claim 2, wherein at least one of the first and second non-fossil fuel units includes an electric power grid.

7. The method of claim 1 and claim 2, wherein at least one of the first and second non-fossil fuel units includes a power storage device.

8. The method of claim 7, wherein the power storage device includes one of a battery and a capacitor.

9. The method of claim 1, wherein at least one of the first and the second HE electric machine includes a HE generator.

10. The method of claim 1, wherein at least one of the first and the second HE electric machine includes a HE motor.

11. The method of claim 1, wherein at least one of the first and the second HE electric machine includes a HE motor co-generation unit.

12. The method of claim 1, wherein at least one of the first and second non-fossil fuel units includes a standard efficiency generator.

13. The method of claim 1, wherein at least one of the first and second non-fossil fuel units includes a standard efficiency motor.

14. The method of claim 1, wherein a connection between the first HE electrical generation unit and the second HE generation unit includes a first efficiency multiplier and a connection between the second HE generation unit and a third HE generation unit includes a second efficiency multiplier.

15. An assembly for providing sustained power self-generation comprising:
a first reduced drag high efficiency (HE) electric machine;
a first non-fossil fuel unit coupled to the first HE electric machine to form an first HE generation unit;
an electrical output connection between the first HE generation unit and an electrical load; and
an electrical feedback connection coupled between the electrical output connection of the first HE generation unit and an electrical input of the first HE generation unit,
wherein:
the electrical output connection outputs a first level of power to the electrical load and outputs a second level of power to the first HE generation unit,
the electrical load includes at least one of: a second HE generation unit including a second HE electric machine and a second non-fossil fuel unit; and a power distribution grid, and
the first and the second HE generation units operate at an efficiency greater than 1 hp of input power to 746 watts of output power.

16. The assembly of claim 15, further comprising:
a power storage device coupled to the electrical output connection, the power storage device capable of having at least a portion of the first electric power supply stored therein.

17. The assembly of claim 15, further comprising:
a power storage device coupled to the electrical output connection, the power storage device capable of having at least a portion of the first electric power supply stored therein; and
a variable frequency drive coupled to the power storage device and the first HE generation unit, the variable frequency drive recovering and returning the stored at least a portion of the first electric power supply as needed.

17. The assembly of claim 15, further comprising:
a power storage device coupled to the electrical output connection, the power storage device capable of having at least a portion of the first electric power supply stored therein; and
a variable frequency drive coupled to the power storage device and the first HE generation unit, the variable frequency drive recovering and returning the stored at least a portion of the first electric power supply as needed.

17. The assembly of claim 15 through claim 17, wherein, wherein at least one of the first and second non-fossil fuel units includes a hydrogen drive system.

18. The assembly of claim 15 through claim 17, wherein at least one of the first and second non-fossil fuel units includes a hydro drive system.

19. The assembly of claim 15 through claim 17, wherein at least one of the first and second non-fossil fuel units includes a hydraulic drive system.

20. The assembly of claim 15 through claim 17, wherein at least one of the first and second non-fossil fuel units includes an electric power grid.

21. The assembly of claim 15 through claim 17, wherein at least one of the first and second non-fossil fuel units includes a power storage device.

22. The assembly of claim 15 through claim 17, wherein the power storage device includes one of a battery and a capacitor.

23. The assembly of claim 15, wherein at least one of the first and the second HE electric machine includes a HE generator.

24. The assembly of claim 15, wherein at least one of the first and the second HE electric machine includes a HE motor.

25. The assembly of claim 15, wherein at least one of the first and the second HE electric machine includes a HE motor co-generation unit.

26. The assembly of claim 15, wherein at least one of the first and second non-fossil fuel units includes a standard efficiency generator.

27. The assembly of claim 15, wherein at least one of the first and second non-fossil fuel units includes a standard efficiency motor.

28. The assembly of claim 15, wherein a connection between the first HE electrical generation unit and the second HE generation unit is constituted according to a first efficiency multiplier.

29. The assembly of claim 15, wherein a connection between the first HE electrical generation unit and the second HE generation unit is constituted according to a first efficiency multiplier and a connection between the second HE generation unit and a third HE generation unit is constituted according to a second efficiency multiplier.

30. The assembly of claim 16, wherein the storage device includes at least one of a battery and a capacitor and wherein the assembly further comprises a rectifier coupled between the electrical feedback connection and the storage device.
